(19) United States
(12) Patent Application Publication
(10) Pub. No.: US 2002/0104833 A1
(43) Pub. Date: Aug. 8, 2002

(54) WELDING HEAD MOUNT FOR ROBOTIC WELDING APPARATUS WITH MICRO ADJUSTMENT CAPABILITY

(75) Inventor: Peter Bradley, Markham (CA)

Correspondence Address: RICHES, MCKENZIE & HERBERT, LLP, SUITE 1800, 2 BLOOR STREET EAST, TORONTO, ON, M4W 3J5, CA

(73) Assignee: Automated Welding Systems Inc.

(21) Appl. No.: 09/778,724

(22) Filed: Feb. 8, 2001

(51) Int. Cl. B23K 26/20; B23K 26/08

(52) U.S. Cl. 219/121.63; 219/121.82

(57) ABSTRACT

An apparatus used to weld adjacent portions of two or more metal workpieces which includes a weld head which is selectively operable to emit a plasma or coherent light source weld beam, a mount or mounting assembly to which the weld head is secured, and a supporting assembly configured to movably support the mount and weld head in movement along the seam line. The mount is used to couple the weld head to a distal end of a robot arm for movement therewith.

### SCOPE OF THE INVENTION

The present invention relates to a welding apparatus used to join adjacent portions of two or more workpieces, and more particularly, a mount for a welding head adapted for use with robotic welding apparatus to form longitudinally elongated weld seams, and which permits micro adjustment of the weld beam position relative to the edge portions of the workpieces to be joined.

### BACKGROUND OF THE INVENTION

The use of robotic welders in the production of workpieces, such as auto body parts and frames is well known. Typically, conventional robotic welders are characterized by a computer programmable robot arm which extends from a proximal end portion coupled to a base of the robot to a remote freely pivoting distal end portion. The distal end portion is movable relative to the base by the relative twisting or bending of arm segments at one or more arm and wrist joints. A welding electrode operable to emit a plasma or other energy beam is mounted at the endmost distal portion of the robot arm. In use, the robot is activated so that the distal end portion is pivoted and/or extended so as to move the welding electrode adjacent to the parts or workpieces which are to be welded.

Conventional robotic welding systems are typically used to perform spot welds where continuous elongated weld seams are not required. In particular, heretofore it has not been possible to program welding robots to reliably perform elongated linear welds, as for example, butt welds having a longitudinal length of ten centimeters or more. Rather, it has been found that the robotic arm joints which permit orthogonal, rotational, twisting and/or co-linear movement of the robot arm segments are susceptible to wear. Over a relatively short period of time, the wear of the robot arm joints may introduce inaccuracies of upto 2 mm or more between the preprogrammed intended positioning of the robot arm and the actual final positioning of the welding electrode. As a result, after a comparatively short period of use, the wear to the mechanical joints of the robot arms is such that the robot arm may no longer reliably position the welding electrode in the correct orientation to precisely perform longitudinally elongated linear or curved welds as the robot arm is moved.

Because of inaccuracies in the robot arm positioning associated with robots used for welding, it has been necessary to use overhead gantry mounted weld heads to perform elongated linear butt or mash welds which are more than 10 cm in length. While accurate, the use of gantry mounted welding heads necessitates that the entire welding apparatus be of a physical size at least as large as the completed blankpiece, so as to permit its movement under the gantry. The comparatively large size of gantry welding systems makes them unsuitable for use where space may be limited or where it may be desirable to customize an existing manufacturing line, as for example, to include an additional welding station.

### SUMMARY OF THE INVENTION

Accordingly, to at least partially overcome the disadvantages of prior art welding systems, the present invention provides for weld head mounting apparatus which is configured for attachment to the movable distal wrist portion of a robot arm, and which permits micro adjustment in the positioning of the emitted energy beam to compensate for variations in the edge portions of the workpieces to be joined and/or wear in the robot arm joints which may produce inaccuracies in the robot arm positioning.

Another object of the invention is to provide a robotic welding apparatus useful to form longitudinally elongated weld seams of ten centimeters or more along the abutting edge portions of two or more workpieces.

Another object of the invention is to provide a light weight and compact mounting apparatus for a welding head which is suitable for use in robotic, gantry or other welding systems, and which permits accurate final positioning and/or adjustment in the output weld beam energy in one or more directions.

A further object of the invention is to provide a compact welding apparatus which is adapted to accurately butt weld two or more workpieces and which may be incorporated into existing welding assembly lines with minimal disruption.

A further object of the invention is to provide a robotic welding system adapted to butt weld the abutting edge portions of two or more sheet metal workpieces to form a tailored blank used in the production of automotive, rail or aircraft body panels or parts.

Another object of the invention is to provide a robotic welding apparatus used to emit a coherent light source as a weld beam to join two or more workpieces along a seam line, and which includes a weld head secured in a light weight mounting assembly adapted to provide micro adjustment in the positioning of the emitted coherent light beam relative to the seam line, while minimizing the weight and/or loading applied to the robot arm.

Another object of the invention is to provide a dual beam laser welding apparatus for forming tailored blanks, and which includes a cantilevered robot arm having a movable distal end portion, a laser head selectively operable to emit a laser beam, and a mounting assembly or mount for coupling the laser head to the distal end portion of the robot arm for movement therewith, and wherein the mount is activatable independently from the pre-programmed bulk movement of the robot arm to permit fine adjustment of the horizontal and/or vertical positioning of the optic head relative to the distal wrist portion and weld seam.

A further object of the invention is to provide a multiple spot laser welding apparatus which includes a laser head secured to a light weight and compact mount adapted to permit fine adjustment in the displacement of the emitted laser beam relative to one or more of the weld seam, the rotational position of the beam relative to the seam line, and the beam focal spot diameter.

The present invention provides an apparatus used to weld adjacent portions of two or more workpieces along a seam line. Although the apparatus may be used in the joining of various different types of workpieces, most preferably the workpieces comprise aluminum, steel or other metal alloy sheets which are joined along abutting edge portions to form tailored blanks used in automotive, rail, aircraft, or other manufacturing industries. The apparatus includes a weld head which is selectively operable to emit a plasma or coherent light source weld beam, a mount or mounting assembly to which the weld head is secured, and a supporting assembly configured to movably support the mount and weld head in movement along the seam line. The supporting assembly may, for example, comprise an overhead gantry support such as that disclosed in U.S. Pat. No. 6,011,240 to Bishop, issued Jan. 4, 2000, but most preferably consists of a conventional robot. Suitable robots include those with an elongated robot arm which extends from a proximal end portion which is coupled to a robot base, to a remote cantilevered distal end portion or wrist which may be pre-programmed for bulk movement along the seam line to be formed. Preferably, one or more robot arm segments connected by twisting joints, rotational joints, revolving joints, collinear joints and/or orthogonal joints provided along the length of the robot arm enable the distal end portion or wrist to move in a horizontal direction relative to the seam line along which a weld seam is formed. The mount is used to couple the weld head to the robot arm at or near the distal end portion for movement therewith. Most preferably, the distal wrist portion of the robot arm, together with the weld head and mount, is movable in a cantilevered manner independently of any collateral support structure over at least part of one of the workpieces to move the emitted weld beam along the abutting edge portions of the workpieces to be joined.

Although not essential, the emitted coherent light source most preferably consists of two or more laser beams formed from either separate laser sources, or by splitting a single coherent light source by means of a splitting mirror, lens or prism. Where multiple laser beams are used in welding, the laser head preferably also includes an adjustment mechanism which permits the orientation of the beams contacting the workpieces to be rotated relative to the longitudinal direction of the weld seam, depending upon any sensed or predetermined gap between the adjacent edges to be joined.

The mount for the weld head is configured to permit adjustment of the horizontal and/or vertical positioning of the weld head relative to the weld seam. Preferably, the mount is configured to permit micro adjustment of the weld head position during welding up to a distance of up to ±30 cm in each direction, and more preferably ±5 mm horizontally and ±10 mm vertically, independently of the robot arm position, so as to compensate for arm wear or inaccuracies in the programmed movement of the robot arm.

In a preferred construction, the mount consists of one and more preferably two hollow sliding frames which are formed from a suitable light weight material such as aluminum or other light weight alloy or composite to minimize weight and loading on the robot arm. The micro adjustment in the positioning of the weld beam is preferably achieved by the sliding of the frames relative to each other and/or the distal end of the robot arm in vertical and/or horizontal movement. To guide the frames in the desired path of movement the weld head mount includes one or more linear slides or bearings, or other suitable guide members provided to ensure the frames slide in each desired direction. Motor driven rack and pinion, or screw adjustment assemblies may be provided to actuate the desired degree of sliding movement of the frames. Most preferably, however, sliding movement of the frames is effected by independently operable separate motor drives which engage a cable pulley blocks.

Accordingly, in one aspect the present invention resides in an apparatus for welding abutting edge portions of two adjacent workpieces along a longitudinally extending weld seam comprising,

a robot having a robot arm extending from a proximal end portion to a distal end portion, said distal end portion being movable relative to said workpieces substantially along said weld seam,

a weld head operable to emit a coherent light source,

a mount for coupling said weld head to said distal end portion with said coherent light oriented towards said edge portions, said mount comprising a first mounting member coupled to said distal end portion and a first slide frame configured for limited sliding movement in a first direction relative to said mounting member,

a motor having a selectively operable output shaft, said motor being coupled to one of said first mounting member and said first slide frame,

a flexible cable coupled to the other of said first mounting member and said first slide frame, said cable including a middle portion extending substantially about said output shaft, and opposing end portions extending in a direction generally parallel to said first direction, wherein the actuation of said motor moves the cable relative to said output shaft in the first direction.

In another aspect, the present invention resides in a mount for a weld head characterized by a first hollow slide frame configured for movement in a first direction, a second slide frame configured for limited sliding movement in a second direction relative to said first slide frame, said second direction being generally normal to said first direction,

a first motor having a selectively operable output shaft, the output shaft of at least one of the first motors being coupled to one of said first slide frame and said second slide frame,

a pulley block coupled to the other of said first slide frame and said second slide frame, said pulley block engaged by the output shaft of said motor, wherein the actuation of said motor moves the pulley block relative to said motor output shaft in the second direction.

In a further aspect, the present invention resides in an apparatus for welding abutting edge portions of workpieces along a weld seam comprising,

a weld head operable to emit an energy beam,

a mount for positioning said weld head in an orientation with said energy beam directed towards said edge portions, said mount comprising,

a first mounting frame and a first hollow slide frame configured for limited sliding movement in a first direction relative to said first mounting frame,

a first motor having a selectively operable output shaft and being coupled to one of said first mounting frame and said first slide frame,

a first cable coupled to the other of said first mounting frame and said first slide frame, said first cable including a middle portion wound substantially about the output shaft, said first motor and opposing end portions extending under tension in a direction generally parallel to said first direction, wherein the actuation of said first motor draws the first cable relative thereto in the first direction,

a second hollow slide frame configured for limited sliding movement in a second direction relative to said first slide frame, said second direction being generally normal to said first direction,

a second motor having a selectively operable output shaft and being coupled to one of said first slide frame and said second slide frame,

a second cable coupled to the other of said first slide frame and said second slide frame, said second cable including a middle portion wound substantially about the output shaft of said second motor, and opposing end portions extending under tension in a direction generally parallel to said second direction, wherein the actuation of said second motor draws the second cable relative thereto in the second direction.

### BRIEF DESCRIPTION OF THE DRAWINGS

Reference is now made to the following detailed description taken together with the accompanying drawings in which:

FIG. 1 illustrates schematically a perspective side view of a welding apparatus used in the production of tailored work blanks in accordance with a preferred aspect of the invention;

FIG. 2 illustrates schematically an enlarged view of the laser head and weld head mount used in the apparatus of FIG. 1;

FIG. 3 shows a partial exploded view of the weld head mount shown in FIG. 2;

FIG. 4 shows an enlarged exploded view of a drive motor and pulley block assembly used in the weld head mount of FIG. 2;

FIG. 5 shows an enlarged perspective view of the motor output shaft and tensioned cable used in the pulley block of FIG. 4;

FIG. 6 shows an enlarged partial schematic view of the focusing lens arrangement used in the laser head of FIG. 1; and

FIGS. 7a and 7b illustrate schematically the relative positioning of an emitted twin spot welding beam used in welding the workpieces.

### DETAILED DESCRIPTION OF THE PREFERRED EMBODIMENT

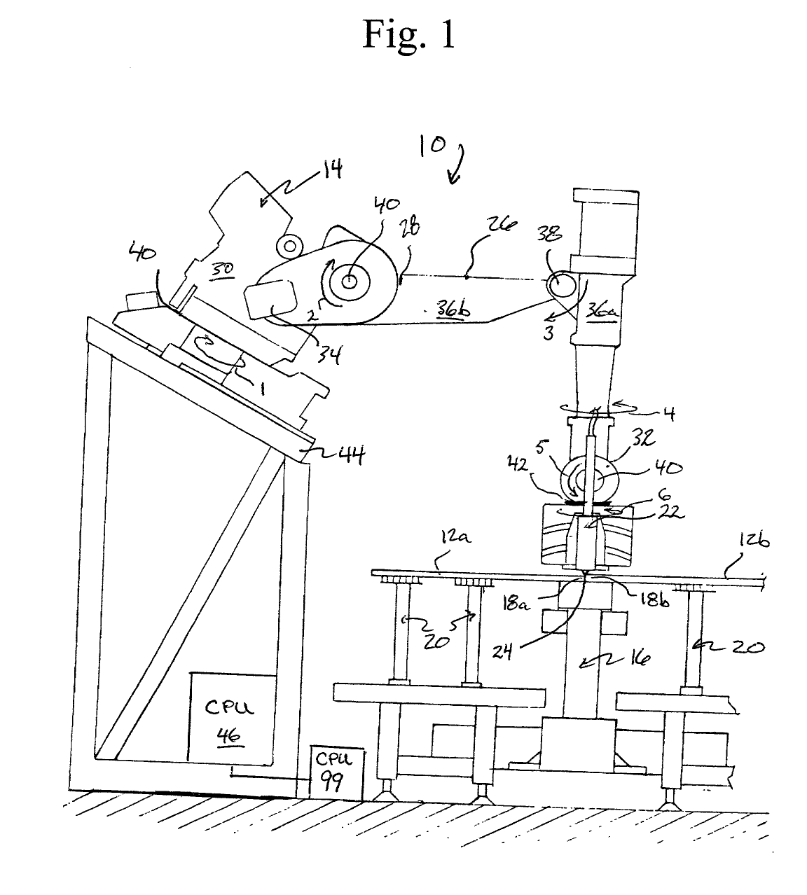

Reference is first made to FIG. 1 which illustrates a welding workstation 10 for butt welding two or more steel, aluminum or other alloy sheet metal workpieces 12a,12b to form a tailored blank for use in the production of automobile body panels and frame parts. The workstation 10 includes a welding robot 14, a clamping assembly 16 for supporting the workpieces 12 with their respective adjacent edge portions 18a,18b to be joined in substantial abutting contact, and a conveyor assembly 20. The conveyor assembly 20 is used to initially move the workpieces 12a,12b into the desired working position on the clamping assembly 16, and following welding operations, thereafter move the completed welded blank from the workstation 10 for further processing. Suitable clamping and conveyor assemblies 18,20 would include those described in U.S. Pat. No. 6,011,240 to Bishop, however, it is to be appreciated that other clamping and conveyor apparatus would also be possible.

As will be described, the welding robot 14 supports and moves a laser head 22 longitudinally in pre-programmed movement along the abutting edge portions 18a,18b of the workpieces 12a,12b, while the laser head 22 is activated to emit a weld beam to melt the metal at the edge portions 18a,18b and form a weld seam 24. Typically, in the production of tailored blanks, the weld seam 24 will be elongated in a longitudinal direction with a length of at least 10 cm, however, shorter weld seams may also be formed, depending on the desired configuration of the tailored blank.

The welding robot 14 includes an elongated articulated robot arm 26 which is pivotally connected at a proximal end portion 28 to a base 30, and which extends to a distal end portion 32. The distal end portion 32 is suspended in a cantilevered-type arrangement by a counterweight 34, so as to be otherwise unsupported and freely movable over the workpiece 12a and/or workpiece 12b and along the abutting edge portions 18a,18b to be joined. It is to be appreciated that the cantilevered arrangement of the robot arm 26 advantageously avoids the necessity of providing a bulkier and more costly overhead gantry. In addition to providing a more compact welding station 10, because the welding robot 14 operates in a position to one side of a workpiece 12a,12b, so long as the arm 26 extends to the weld seam 24, as contrasted with gantry-type systems which must be sufficiently large to permit the entire tailored blank to move therethrough, the welding station 10 may be used in the production of larger tailored blanks. FIG. 1 shows best the robot arm 26 as comprising two steel arm segments 36a,36b, each movably connected by gearing at a hinged elbow joint 38. As is known, the robot base 30 and arm 26 are further provided with additional hydraulic and/or gear operated twisting, orthogonal and rotational joints 40 which enable a wrist 42 positioned at the distalmost end of the robot arm 26 to reciprocally travel about 6 separate axis in the direction of arrows 1, 2, 3, 4, 5, 6 in either linear or curved movement over the workpieces 12a,12b. A microprocessor (CPU) 46 provides control signals to internal robot motors (not shown) to selectively move the segments 36a,36b relative to each other, and direct the bulk positioning of the robot wrist 42 in pre-programmed movement substantially along the seam line 24. Although not shown, it is to be appreciated that the robot arm 26 could additionally include co-linear joints, as well as revolving joints to provide the robot arm wrist 42 with the desired degree of movement, depending on the configuration of the seam line 24. While the CPU 46 provides signals to the robot 14 which move the wrist 42 in bulk movement along the seam line 24, it is to be appreciated that as a result of variances in the stamping and/or finishing of the workpieces 12a,12b and wear of the robot arm joints 38,40, the actual positioning of the weld head 22 relative to the desired pre-programmed position of the weld head 22 may vary by 2 mm or more.

Although not essential, the base 30 of the robot 14 is preferably positioned on a platform 44 which is inclined downwardly towards the workpieces 12a,12b and the weld seam 24. More preferably, the platform 44 is inclined at an angle between about 15 and 40 degrees, and most preferably about 30 degrees. The inclination of the platform 44 advantageously maximizes the envelope of movement through which the robot arm wrist 42 may move, increasing the versatility of the welding robot 14.

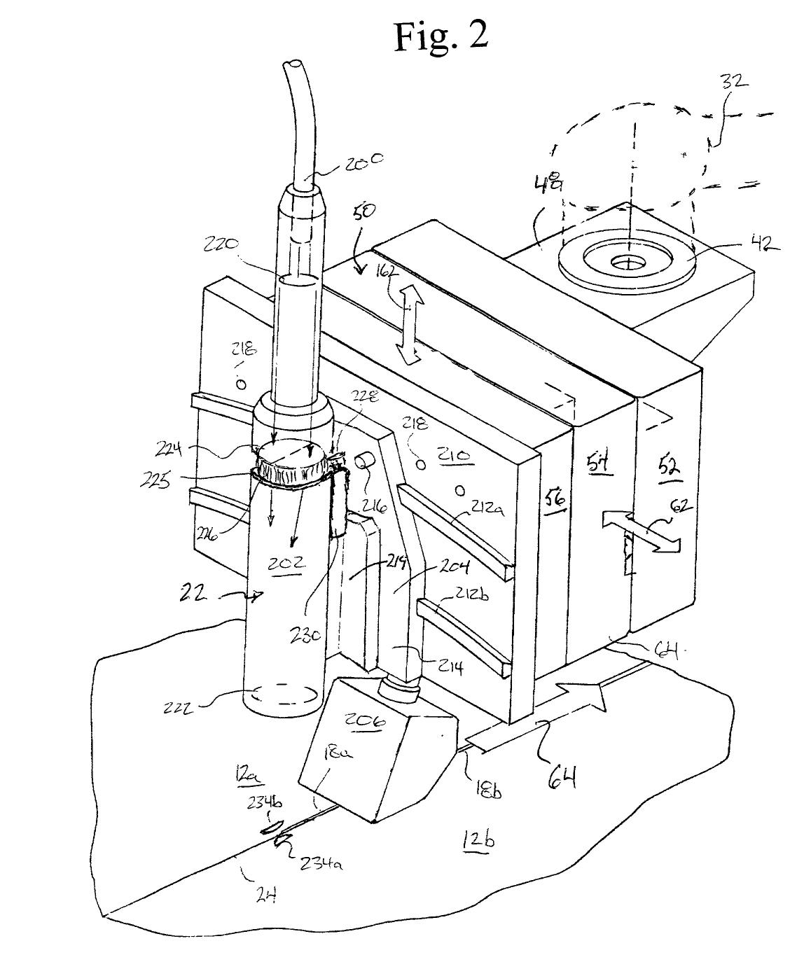

FIG. 2 illustrates best the wrist 42 as including a support plate 48 having a generally L-shaped profile. The support plate 48 is adapted to matingly couple to and support a laser head mount 50 which is used to secure the weld head 22 in the desired orientation to the robot arm 26. As will be described, the mount 50 couples the laser head 22 to the robot arm wrist 42, while permitting micro-adjustment in the horizontal and vertical positioning of the weld head 22 and the emitted laser beam ±5 mm horizontally and ±10 mm vertically. Preferably, the mount 50 enables adjustment in the weld head 22 position independently from the programmed movement of the laser arm 26 and the bulk positioning of the wrist 42. Although not essential, to simplify the automation of the welding workstation 10, the robot arm 26 is preferably programmed so that in use the support plate 48 is maintained in a comparatively fixed position relative to the seam line 24, and in a most simplified embodiment in a position selected so that the wrist 42 is maintained in a generally constant horizontal elevation above the workpieces 12a,12b as it is moved along the weld seam 24.

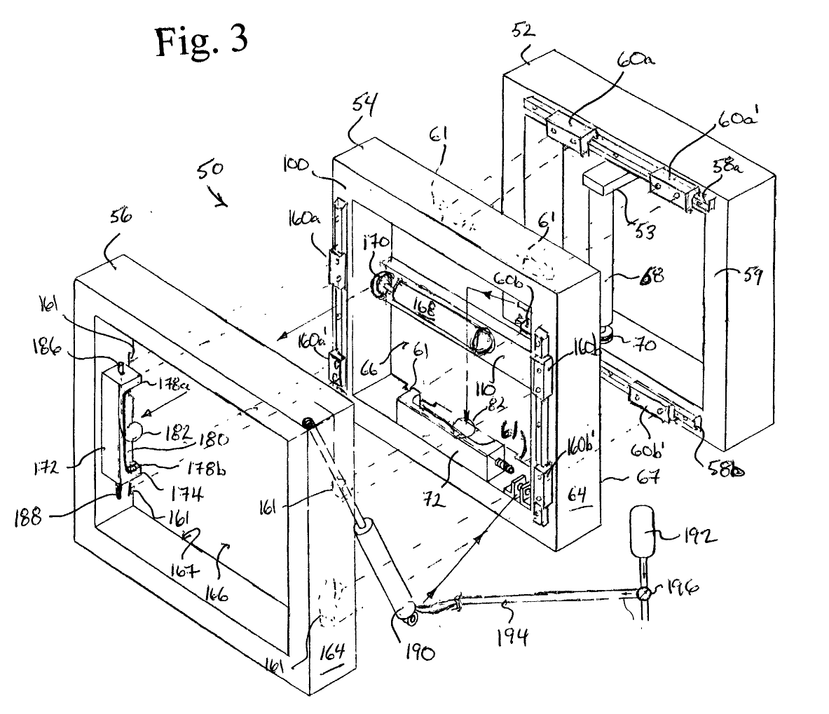

The laser head mount 50 includes a hollow fixed frame 52, a horizontal slide frame 54 and a vertical slide frame 56 which carries the laser head 22. The fixed frame 52 is made of aluminum and is configured to be coupled directly to a vertically extending side of the support plate 48 by a series of bolts (not shown) so as to be substantially coplanar therewith. As shown best in FIG. 3, the frame 52 includes an opposing pair of parallel half slide rails 58a,58b such as HR™ slide rails sold by THK America, Inc. of Illinois, USA, which is secured to and projects beyond the upper and lower sides of its forward face 59. The side rails 58a,58b are oriented so that when the frame 52 is secured to the support plate 48 and the wrist 42 is moved to a horizontal orientation, the slide rails 58a,58b are elongated in a horizontal orientation extending transverse to the longitudinal extent of the weld seam 24. Most preferably, the rails 58a,58b are spaced apart as far as possible to provide maximum stability.

FIG. 3 shows best the horizontal slide frame 54 as having a peripherally extending aluminum sidewall 64 which defines an open interior cavity 66. The slide frame 54 includes two spaced apart pairs of bearing blocks 60a,60a′ and 60b,60b′ (shown in exploded view) which slidably engage the rails 58a,58b, respectively. The bearing blocks 60a,60a′ and 60b,60b′ are each secured within an associated recess 61 formed in a rear face 67 of each opposing vertical side of the sidewall 64 by screws. The bearing blocks 60a, 60a′ and 60b,60b′ have a complementary profile corresponding to that of the slide rails 58a,58b so as to engage the sides of the rails 58a,58b and lock frame 54 to the frame 52 while permitting sliding movement of the frame 54 along the rails 58a,58b in their direction of elongation, while preventing vertical movement of the frame 54.

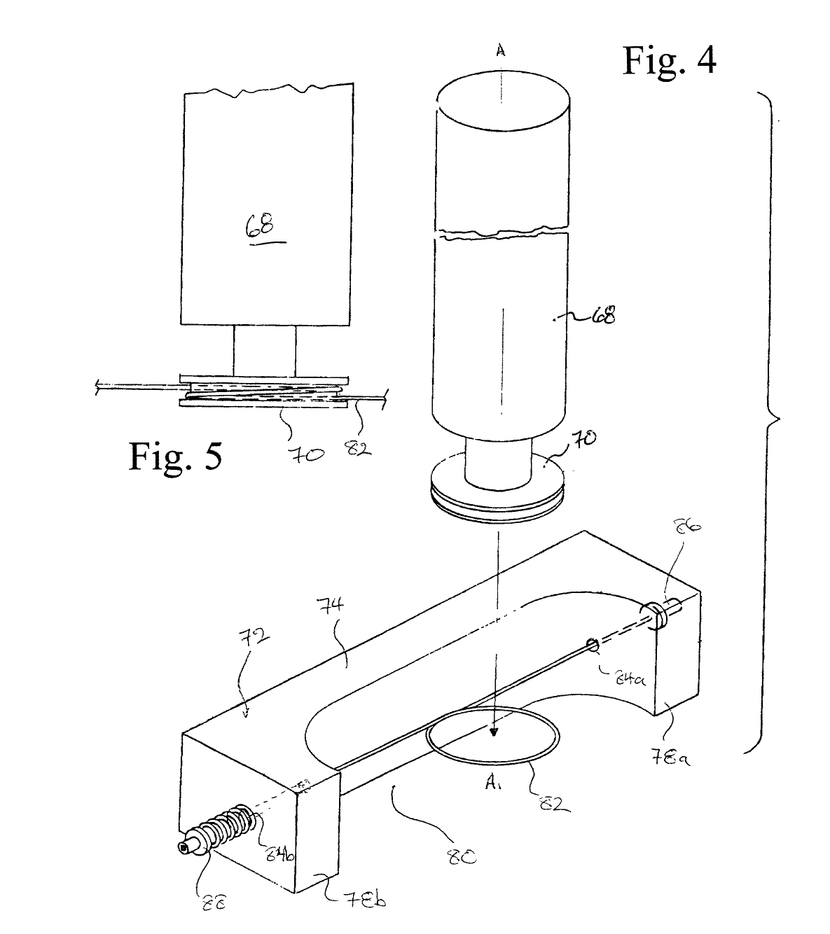

FIGS. 2, 3 and 4 show best a DC servo motor 68 having a selectively rotatable output shaft 70 as being fixedly secured to the frame 52 by a bracket 53, so as to extend forwardly therefrom into the open interior of the cavity 66. Preferably, the motor 68 comprises a brushless DC servo motor with harmonic drive gearing, as for example, is sold by HD Systems Inc. The motor 68 is mounted to the frame 52 so that the axis A-A₁ of the output shaft 70 (FIG. 4) is in a generally vertical orientation perpendicular to the direction of horizontal sliding movement of the frame 54. A cable pulley block 72 is secured along an inner bottom surface of the sidewall 64. Most preferably, the pulley block 72 consists of a generally U-shaped aluminum base 74 (FIG. 4), which includes a pair of arms 78a,78b, and which define a central bight 80 sized to receive the output shaft 70 therein. A flexible steel aircraft cable 82 is coupled to the base 74 by passing the cable through a pair of marginally offset bores 84a,84b formed through each arm 78a,78b, respectively. One end of the cable 82 is secured to the first arm 78a of the U-shaped base 74 by extending through the bore 84a and permanently securing a crimped fastener 86 to the end of the cable 82 projecting therefrom. As shown best in FIGS. 4 and 5, the pulley block 72 is positioned with the output shaft 70 located in the bight 80 and the cable 82 extending generally perpendicular to the axis A-A₁. The cable 82 is wound around the output shaft 70 so as not to overlap itself (FIG. 5) with the opposite end of the cable 82 fed through the bore 84b in the opposite arm 78b of the block 72. The end of the cable 82 which is fed through arm 78b is held under tension by a resiliently compressible spring 88 so as to prevent slippage of the cable 82 relative to the output shaft 70. Preferably, the arms 78a,78b of the U-shaped base 74 are separated from each other by a distance of between 1 and 10 cm and more preferably about 3 cm. This spacing is selected to permit positioning of the output shaft 70 between the arms 78a,78b with the shaft axis A-A₁ aligned with the bores 84a,84b. The motor 68 is independently controlled by means of a secondary CPU 99 (FIG. 1) which may operate independently, however, is most preferably electrically linked to CPU 46. In operation, the rotation of the motor output shaft 70 in either direction draws the cable 82 and pulley block 72 in either direction perpendicular to axis A-A₁. As such, with the pulley block 72 secured to the interior of the horizontal slide frame 54 and engaged by the motor output shaft 70, the selective operation of the motor 68 in either a forward or reverse direction moves the pulley block 72 to draw the slide frame 54 along the slide rails 58a,58b relative to the mounting frame 52. The sliding movement of the bearing blocks 60a,60a′ and 60b,60b′ along the slide rails 58a,58b ensures that the horizontal slide frame 54 moves together with the vertical slide frame 56 and laser head 22 in a lateral direction of arrow 62 (FIG. 2) generally perpendicular to the welding direction of arrow 64. In this manner, the horizontal positioning of the emitted beam is adjusted relative to the edge portions 18a,18b to an optimum welding orientation relative to the seam 24.

The use of the flexible cable 82 and the U-shaped base 74 is advantageous in that it permits the fixed frame 52 and sliding frame 54 to be constructed with minimum weight, as contrasted with heavier rack and pinion and screw drive systems. It is to be appreciated that minimizing the weight carried by the distal wrist 42 of the robot arm 26 prolongs the operational life of the robot 14 and reduces the likelihood of premature failure of the mechanical joints 38,40.

FIG. 3 shows best a second DC motor 168 mounted within the cavity 66 and which is used to vertically raise or lower the slide frame 56. The motor 168 is identical to motor 68, and coupled to the frame sidewall 64 by means of a mounting bracket 110 so as to extend forwardly therefrom past the forward face 100 of the frame 54 in an orientation perpendicular to that of motor 68.

The vertical slide frame 56 includes an aluminum sidewall 164 generally corresponding in peripheral dimension to sidewall 64, and which defines a hollow interior cavity 166. The vertical slide frame 56 includes pairs of slide blocks 160a,160a′ and 160b,160b′ (shown in exploded view) which are each partially positioned within an associated recess 161 formed in the rearward face 167 of the top and bottom sides of the sidewall 164. The slide frame 164 is movably coupled to the horizontal slide frame 54 by the engagement of the slide blocks 160a,160a′ and 160b,160b′ with a pair of vertically positioned slide rails 158a,158b which are secured to the forward face 100 of each vertical side of the frame 54. Like slide rails 58a,58b, the vertical slide rails 158a,158b have a profile selected so as to lock the frames 56,54 together in single axis movement along the direction of rail 158 elongation when the rails 158 are engaged by the slide blocks 160. It is to be appreciated that the slide blocks 160a,160a′ and 160b,160b′ are positioned in the recess 161 in an orientation so as to engage the longitudinal edges of the slide bearing 158 and substantially prevent horizontal movement of the vertical slide frame 56 relative to the horizontal slide frame 54, locking the frames 56,54 together. As will be described, the slide rails 158a,158b are mounted in a position perpendicular to that of slide rails 58a,58b so as to permit the slide frame 56 to travel only in the direction of arrow 162 (FIG. 2), perpendicular to that of arrow 62.

A second U-shaped pulley block 172 having substantially the identical overall configuration of pulley block 72 is positioned along a side portion of the frame sidewall 164. The pulley block 172 includes a U-shaped base 174 with a pair of arms 178a,178b spaced approximately 1 to 10 cm apart, and most preferably 4.4 cm, apart forming a central bight 180 therebetween. A flexible metal aircraft cable 182 is passed through bores 184a,184b formed in each arm 178a,178b and secured thereto by a crimped fastener 186 and compressed spring 188, respectively. As shown best in FIG. 3, the output shaft 170 of motor 168 extends horizontally in an orientation so as to engage the cable 182. The pulley block 172 is secured to the inner portion of sidewall 164 mounted in an orientation with the output shaft 170 of the servo motor 168 positioned within the bight 180, and the flexible steel aircraft cable wound about the output shaft 170 in the identical manner as the cable 80 of pulley block 72 is coupled to the servo motor 68.

FIG. 3 further shows the mount 50 as including a pressurized air cylinder 190. The air cylinder 190 is joined at one end to an inner surface of the sidewall 64 of the horizontal slide frame 54, and at its other end to the inner surface of the sidewall 164 of vertical slide frame 154. The cylinder 190 is pressurized by means of a pressurized gas supply 192 and conduit tube 194. A regulator 196 is provided to selectively supply or exhaust gas from the cylinder 190 to compensate for the weight of the vertical slide frame 56 and laser head 22, and maintain the slide frame 56 in a neutral position, so as to be movable to a raised or lowered position by the operation of the motor 168. It is to be appreciated that the configuration of the laser head mount 50 is such as to minimize the loading on the vertical slide frame 56. In this regard, the frames 52,54,56 are made of aluminum or other suitable like material and the motors 68,168 are carried by the portions of the mount 50 which are not movable in the vertical direction.

The applicant has appreciated that the use of the DC motor 68,168 and cable pulley block 72,172 arrangement advantageously permits the weld head mount 50 to be constructed with a reduced weight, while ensuring accurate control of the relative sliding of the frames 54,56. Advantageously, the use of the cables 82,182 wound about the output shafts 70,170, avoids side loading on the motors 68,168 and the shafts 70,170. As such, only torsional loads are placed on the motors 68,168 in moving the slides 56,54 in their respective vertical and horizontal directions.

FIG. 2 illustrates best the mounting of the laser head 22 to the vertical slide frame 56. The laser head 22 includes a fiber optic coupling 200, a collating lens assembly 202, a tilting assembly 204 and a seam tracking sensor 206. FIG. 2 shows best the tilting assembly 204 as including a generally vertically oriented mounting plate 210 which may be either integrally formed as part of the frame 56, or alternately, constructed as a separate piece secured to a forward face of the vertical slide frame 56 by a series of bolts (not shown). The tilting assembly 204 further includes a pair of arcuate slides 212a,212b and a tilting block 214 to which the lens assembly 202 is secured. The block 214 is adapted for sliding movement along the arcuate slides 212a,212b to move the lens assembly 202 and any emitted beam to an inclined orientation relative to the seam line 24. A locking pin 216 extends through the slide block 214 to selectively engage one of a series of locating holes 218 formed in the mounting plate 210, and whereby the engagement of the pin 216 with a hole 218 secures the slide block 214 at the desired angle. It is to be appreciated, however, that a screw feed, or pneumatic or hydraulic extension cylinder could be used in place of the pin 216 and hole 218 arrangement to selectively position the slide block 214 at a desired inclined angle. A focus adjustment slide 219 using split rails or bearings (not shown) is used to move the lens assembly 202 in a direction parallel to the emitted weld beam and at any tilt angle to permit the manual adjustment of the beam focus position.

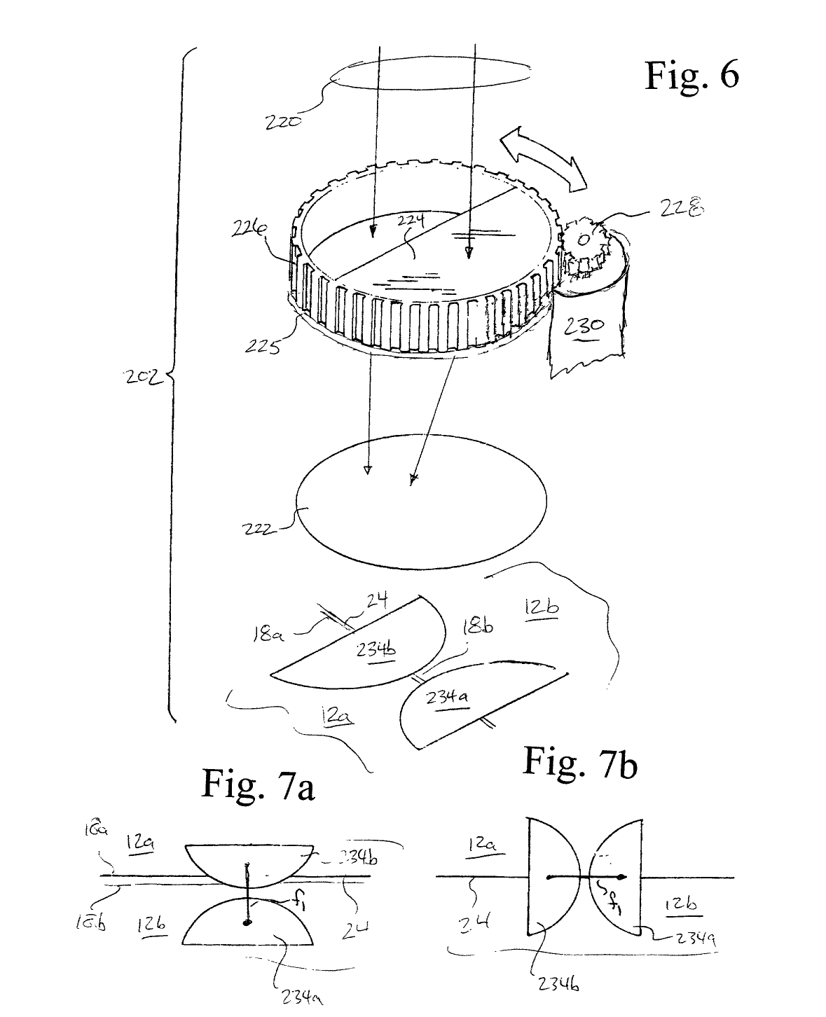

The laser head 22 is most preferably adapted to deliver a yttrium aluminum garnet (YAG) coherent light source to the weld seam 24, with laser energy is supplied from a generator (not shown) to the lens assembly 202 via the fiber optic coupling 200. As shown best in FIGS. 2 and 6, the lens assembly 202 includes a pair of collating lenses 220,222 positioned on either side of a rotating semi-circular prism 224 positioned in a rotary bearing 225. A rack 226 extends radially about the periphery of the prism 224. The rack 226 is engaged by a pinion 228 provided on an output shaft of a microprocessor controlled DC servo motor 230 whereby the selective activation of the motor 230 rotates the prism 224.

The coherent light energy travels from the fiber optic coupling 200 through the first collimating lens 220 which refocuses the laser energy more closely into a parallel path. In the lens assembly 202, the parallel laser energy next passes through the selectively rotatable semicircular prism 224. The prism 224 is preferably located so as to bisect approximately half the refocused beam at its optic center. The portion of the coherent light beam which strikes the prism 224 is refracted relative to a remainder of the coherent light beam, producing a split twin spot coherent light beam. The split beam passes through the second refocusing lens 222 which refocuses and directs the two coherent light spots 234a,232b towards the adjacent portions 18a,18b of the workpieces 12a,12b to be joined.

Although not essential, the seam tracking sensor 206 most preferably includes a coherent light source emitter and receptor which emits a coherent light source immediately ahead of the welding composite beam 234a,234b. The seam tracking sensor 206 provides signals to a CPU 46 which also provides an indication of any spacing between the abutting edge portions 18a,18b where welding is taking place.

The seam tracking sensor 206, motor 68, motor 168 and motor 230 are preferably all electronically coupled to the CPU 99. As will be described, the sensor 206 is adapted to provide signals to the CPU 99 indicative of the vertical and horizontal position of the adjacent edge portions 18a,18b which are to be joined, as well as any gap spacing which may exist therebetween. From the input data supplied by the sensor 206, the CPU 99 independently outputs control signals to the motors 68,168 to adjust the horizontal and/or vertical position of the weld head 22 relative to the workpieces 12a,12b; as well as motor 230 to effect the rotation of the prism 224 so as to change the orientation of the spots 234a,234b relative to the seam line 24.

In use of the apparatus 10, the sheet metal workpieces 12a,12b are moved by the conveyor assembly 20 into a working position next to the welding robot 14 with the adjacent edge portions 18a,18b to be joined in a substantially abutting orientation. The clamping assembly 16 is then activated to secure the workpieces 12a,12b during welding operations. Once the workpieces 12a,12b are secure, the welding robot 14 is initialized to butt weld the sheets 12a,12b together. Welding is performed with the CPU 46 controlling the bulk movement of the robot arm wrist 42, so as to move the laser head 22 horizontally along a pre-programmed path generally corresponding to the portions of the edges 18a,18b to be joined. Welding may be performed on a variety of different workpieces 12a,12b by pre-programming the CPU 46 to move the robot arm 26 to move along different preset and predetermined paths depending upon the blank to be formed. Most preferably, with the initial bulk positioning of the welding robot 14, the horizontal sliding frame 54 is oriented so as to slide in horizontal movement in the direction generally transverse to the longitudinal extent of the weld seam 24. The seam tracking sensor 206 further provides initial signals to the CPU 99 identifying the precise position of the seam line 24, which in turn provides control signals to the DC servo motors 68,168, to adjust the positioning of horizontal and vertical slide frames 54,56 independently from the bulk movements of the robot arm 26.

The robot arm 26 is then moved with the wrist 42 maintained in a substantially constant horizontal orientation so as to move the weld head 22 in the general direction along the weld seam 24. Concurrently with the movement of the robot arm 26, the seam tracking sensor 206 continuously provides signals to the CPU 99 indicative of at least one, and preferably each of the horizontal travel of the weld seam 24, changes in the vertical positioning of the workpieces 12a,12b occurring, and any gap spacing between the abutting edge portions 18a,18b to be joined.

The CPU 99 is used to provide signals to the motors 68,168 to effect the micro adjustment in the position of horizontal and vertical slide frames 54,56 to compensate for any horizontal and vertical deviations, while the laser generator is operated to output the coherent light beam to butt weld the workpieces 12a,12b. In particular, simultaneously with welding operation and the movement of the arm, 26 the CPU 99 independently operates the servo motor 68 to move the horizontal slide frame 54 laterally to maintain the position of the twin spot beam 234a,234b at the optimum position relative to the weld seam 24 to achieve the desired weld properties. The seam tracking sensor 206 further provides information with respect to the surface position of the component blanks 12a,12b to compensate for any changes in thickness of the workpieces 12a,12b or bows in the sheets 12a,12b as welding is performed. In this regard, during welding, the seam tracking sensor 206 provides control signals to the CPU 99 to activate the motor 168 and move the vertical slide frame 56 up or down. This provides continuous adjustment in the vertical height of the laser head 22, and maintains the optimum focal diameter of the spots 234a,234b at the workpiece 12a,12b surfaces during welding.

It is to be appreciated that because final adjustment of the weld beam location and focal diameter is performed independently from the movement of the robot arm 26, the robot 14 itself needs only to perform approximate positioning of the weld head 22. As such, it is not necessary that the robot arm 26 movement be highly accurate. In particular, it has been found that overall accuracy in positioning along the entire weld seam is less critical. Rather, accuracy is most preferably maintained within the distance (approximately 4.5 cm) the weld head 22 is moved between the tracking sensor 206 and the weld spots 234 to achieve optimum weld characteristics.

As shown best in FIGS. 6 and 7, simultaneously during welding, the DC servo motor 230 is actuated by the CPU 99 to selectively position the twin spots 234a,234b so that the focal line f₁ (FIGS. 7a and 7b) defined as the line intersecting the optic center of each coherent beam spot 234a,234b at the surface of the workpieces 12a,12b is moved between a position more closely aligned with the longitudinal extent of the weld seam 24, and a non-aligned orientation moved towards a position more transverse therefrom. Most preferably, the beam spots 234a,234b are movable between an orientation directly aligned with a longitudinal extent of the weld seam 24 and an orientation of between about 30 and 90 degrees relative thereto. It is to be appreciated that with the pinion 228 engaging the rack 226, the activation of the motor 230 rotates the prism 224 to produce a corresponding rotation in the orientation of the output twin spot beam 234a,234b. When the seam tracking sensor 206 identifies a gap spacing between the abutting edge portions 18a,18b of the workpieces 12a,12b larger than a predetermined critical gap spacing, the servo motor 230 is activated to rotate the prism to move the beam from a position where the focal line f₁ substantially aligned with the weld seam to the non-aligned position. Further, once the seam tracking sensor 206 determines that the gap spacing is within the predetermined minimum tolerance, the CPU 46 is used to re-activate the servo motor 230 to return the prism 224 so that the orientation of the beam focal line f₁ generally aligns with the longitudinal extent of the weld seam 24.

Optionally, the welding apparatus 10 may further include one or more micro processors which control laser output power, and/or the speed of movement of which the laser head 22 is moved along the weld seam 24 by the robot arm 26, having regard to the gap spacing and/or the orientation of the focal line f₁ relative to the seam line 24. Optionally, microprocessors may further be used to control the speed and/or maximum angle of rotation of the weld beam.

Although the disclosure describes the present apparatus 10 as used in the production of tailored blanks for use in the automotive industry, the invention is not so limited. It is to be appreciated that the present invention is suitable to weld almost any metal sheets made of steel, aluminum or other metals or alloys for use in a variety of industries, including without limitation, aircraft, rail car or other vehicle production.

Although the preferred embodiment of the invention describes the use of a U-shaped cable pulley block 72 having a flexible cable 82 as engaging the output shaft 70 of the motor 68, the invention is not so limited. It is to be appreciated that other mechanisms for effecting the movement of the horizontal and vertical sliding frames 54,56 are also possible, including without limitation, the use of threaded screws, belt drives, stepping motors and rack and pinion drives.

While the preferred embodiment illustrates a linear bearing 58 arranged to guide the sliding frame 54 in horizontal movement relative to the fixed mounting plate 48, the invention is not so limited. Other guides may also be used. Similarly, while preferably the bearing 58 is configured so that the horizontal movement of the sliding frame 54 occurs in a direction generally transverse to the longitudinal extent of the weld seam 24, other sliding configurations also remain possible.

Although the preferred embodiment describes the welding apparatus 10 as including a laser head 22 adapted to emit a twin spot composite beam, the invention is not so limited. The present invention is equally suitable for use with plasma and other types of welding apparatus, as well as laser welding apparatus which emit either a single beam or multiple beams.

Although the disclosure describes and illustrates various preferred embodiments, the invention is not so limited. Many modifications and variations will now occur to persons skilled in the art. For a definition of the invention, reference may be had to the appended claims.

We claim:

1. An apparatus for welding abutting edge portions of two adjacent workpieces along a longitudinally extending weld seam comprising,
a robot having a robot arm extending from a proximal end portion to a distal end portion, said distal end portion being movable relative to said workpieces substantially along said weld seam,
a weld head operable to emit a coherent light source,
a mount for coupling said weld head to said distal end portion with said coherent light oriented towards said edge portions, said mount comprising a first mounting member coupled to said distal end portion and a first slide frame configured for limited sliding movement in a first direction relative to said mounting member,
a motor having a selectively operable output shaft, said motor being coupled to one of said first mounting member and said first slide frame,
a flexible cable coupled to the other of said first mounting member and said first slide frame, said cable including a middle portion extending substantially about said output shaft, and opposing end portions extending in a direction generally parallel to said first direction, wherein the actuation of said motor moves the cable relative to said output shaft in the first direction.

2. An apparatus as claimed in claim 1 wherein said motor comprises a DC servomotor comprising at least one harmonic drive gear.

3. An apparatus as claimed in claim 1 wherein said apparatus further includes a resilient tensioning spring for maintaining at least one of said end portions of said cable under tension.

4. An apparatus as claimed in claim 1 wherein said first direction comprises a horizontal direction substantially transverse to the longitudinal extent of said weld seam.

5. An apparatus as claimed in claim 1 wherein said workpieces comprise substantially planar metal sheets and said coherent light source comprises a plurality of laser beams, and said apparatus further including an adjustment mechanism for adjusting the positioning of the laser beams relative to the said seam line.

6. An apparatus as claimed in claim 6 wherein said adjustment mechanism comprises a prism configured to split a single coherent light source into two or more of said laser beams, a rotary bearing adapted to selectively rotate said prism in a plane substantially parallel to a plane of said sheet blanks, and a drive for selectively rotating said rotary bearing.

7. An apparatus as claimed in claim 3 wherein said opposing end portions are held under tension in an orientation substantially tangential to a peripheral surface of said output shaft.

8. An apparatus as claimed in claim 1 further comprising a guide mounted to a first one of said mounting member and said first slide frame for guiding said first slide frame in movement in said first direction, said guide being elongated in said first direction, and a bearing member mounted to a second other one of said mounting member and said first slide frame and slidably engaging said guide and whereby the engagement of said bearing member with said guide substantially locking said mounting member and said first slide frame together in single axis movement in said first direction.

9. An apparatus as claimed in claim 1 further including a second slide frame configured for limited sliding movement in a second direction relative to said first slide frame, said second direction being generally normal to said first direction,
a second motor having a selectively operable output shaft and being coupled to one of said first slide frame and said second slide frame,
a second cable coupled to the other of said first slide frame and said second slide frame, said second cable including a middle portion extending substantially about said output shaft of said second motor, and opposing end portions extending in a direction generally parallel to said second direction, wherein the actuation of said second motor moves the second cable relative to said second motor output shaft in the second direction.

10. An apparatus as claimed in claim 8 wherein said apparatus further includes a resilient tensioning spring for maintaining said end portions of said cable under tension.

11. An apparatus as claimed in claim 1 wherein said workpieces comprise substantially planar tailored blanks, and said distal end portion is movable in a plane substantially parallel to a planar surface of said tailored blanks.

12. An apparatus for welding abutting edge portions of workpieces along a weld seam comprising,
a weld head operable to emit an energy beam,
a mount for positioning said weld head in an orientation with said energy beam directed towards said edge portions, said mount comprising,
a first mounting frame and a first hollow slide frame configured for limited sliding movement in a first direction relative to said first mounting frame,
a first motor having a selectively operable output shaft and being coupled to one of said first mounting frame and said first slide frame,
a first cable coupled to the other of said first mounting frame and said first slide frame, said first cable including a middle portion wound substantially about the output shaft, said first motor and opposing end portions extending in a direction generally parallel to said first direction, wherein the actuation of said first motor draws the first cable relative thereto in the first direction,
a second hollow slide frame configured for limited sliding movement in a second direction relative to said first slide frame, said second direction being generally normal to said first direction,
a second motor having a selectively operable output shaft and being coupled to one of said first slide frame and said second slide frame,
a second cable coupled to the other of said first slide frame and said second slide frame, said second cable including a middle portion wound substantially about the output shaft of said second motor, and opposing end portions extending in a direction generally parallel to said second direction, wherein the actuation of said second motor draws the second cable relative thereto in the second direction.

13. An apparatus as claimed in claim 13 further including a resilient tensioning spring for maintaining said end portions of said first cable under tension.

14. An apparatus as claimed in claim 13 wherein said first direction comprises a horizontal direction substantially transverse to the longitudinal extent of said weld seam.

15. An apparatus as claimed in claim 15 wherein said workpieces comprise substantially planar metal sheet blanks wherein said coherent light source comprises a plurality of laser beams, and said apparatus further including an adjustment mechanism for adjusting the positioning of the laser beams relative to the said seam line.
